(19) United States
(12) Patent Application Publication
(10) Pub. No.: US 2005/0108101 A1
(43) Pub. Date: May 19, 2005

(54) Method and system to link orders with quotations

(75) Inventors: Ming Ta Hsu, Hsin-Chu (TW); Grace Lin, Hsin-Chu (TW); Cho Yi Huang, Hsin-Chu (TW); Jeffrey Bunce, Hsin-Chu (TW); Jyh-Hwa Chen, Hsin-Chu (TW); Hsin-Nien Chen, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/712,880

(22) Filed: Nov. 13, 2003

(51) Int. Cl. G06F 17/60

(52) U.S. Cl. 705/26

(57) ABSTRACT

A computer-implemented method and system for linking a semiconductor product manufacturing facility order with one or more quotations are provided. A quotation including at least a first product and its quote amount is received and stored. A product manufacturing facility order that identifies at least the first product and desired quantity is also received. Then an order price associated with the first product calculated by accessing the stored quote amount associated with the first product, and determining the order price based on the quote amount associated with the first product and the desired quantity identified in the product manufacturing facility order.

### TECHNICAL FIELD

The patent relates in general to managing semiconductor fabrication facilities, and more specifically to a link between a product manufacturing facility (such as a semiconductor foundry) order and a quotation.

### BACKGROUND INFORMATION

In a semiconductor manufacturing business such as a semiconductor foundry business, one may quote prices to customers based on technologies employed in making devices and based on product options. Technology may be specified by identifying minimum line width (e.g., 0.18 μM), metal composition (e.g., Cu), number of metal layers (e.g., seven metal layers), gate material (e.g., Salicide), and other aspects of technology. Product options may include feature inclusion such as circuit probe capability, color filter, bumping, and other product options.

The customer may place an order by identifying a specific device or devices. In this case, the sales administrator taking the order may need to look up manually the technologies and options employed in making the device to determine the pricing to apply, since there may be no linkage between a previous quotation or quotations and this customer order. This manual procedure takes a lot of time and is subject to error. When errors are made in pricing orders, customers may be displeased.

Accordingly, what is needed is a mechanism and system to link a product manufacturing facility (such as the semiconductor foundry) customer order to the customer quotation or quotations.

### SUMMARY

In one embodiment, a computer-implemented method for linking a semiconductor product manufacturing facility order with one or more quotations is provided, which comprises, receiving the quotation including at least a first product and its quote amount; storing the quote amount associated with the first product; receiving the product manufacturing facility order that identifies at least the first product and desired quantity; and calculating an order price associated with the first product. The calculation is performed by accessing the stored quote amount associated with the first product, and determining the order price based on the quote amount associated with the first product and the desired quantity identified in the product manufacturing facility order.

In another embodiment, a computer-implemented method for linking a semiconductor product manufacturing facility order with one or more quotes in a quotation in is provided, which comprises: receiving the quotation including at least two products and their respective quote amounts; storing the two quote amounts; receiving the product manufacturing facility order that identifies at least the two products and their respective desired quantities; and calculating order prices associated with the at least two products. The calculations are performed by accessing the quote amounts associated with the products, and determining the order prices based on the respective quote amounts associated with the products and their respective desired quantities identified in the product manufacturing facility order.

In yet another embodiment, a computer-readable medium having stored thereon sequences of instruction for responding to a request for linking a semiconductor product manufacturing facility order with one or more quotations is provided, which comprises instructions for performing the steps of: receiving the quotation including at least a first product and its quote amount; storing the quote amount; receiving the product manufacturing facility order that identifies at least the first product and desired quantity; and calculating an order price associated with the first product. The calculation is performed by accessing the quote amount associated with the first product, and determining the order price based on the quote amount associated with the first product and the quantity identified in the product manufacturing facility order.

In another embodiment, a system for linking a product manufacturing facility order with one or more quotations is provided, which comprise: a quotation entry device for entering the quotation that includes at least a first product and its quote amount; memory connected to the data entry device configured to receive the quote amount; an order entry device for entering the product manufacturing facility order that identifies at least the first ordered product and the desired quantity; and a price calculator configured to receive the product manufacturing facility order from the order entry device, to access the memory to identify the quote amount associated with the ordered product, and to calculate a price for the product based on the desired quantity and the quote amount.

### BRIEF DESCRIPTION OF THE DRAWINGS

FIG. 1 depicts a system for linking semiconductor foundry quotations with customer orders.

FIG. 2 depicts a process for updating a database table that maps a semiconductor foundry product to a quotation.

FIG. 3 depicts a process for creating a semiconductor foundry order which is linked to a quotation.

FIG. 4 depicts an example graphical user interface screen for entering a semiconductor foundry order.

FIG. 5 depicts an example graphical user interface screen for creating a semiconductor foundry quotation.

FIG. 6 depicts an example virtual integrated circuit fabrication system.

FIG. 7 depicts an alternate virtual integrated circuit fabrication system.

FIG. 8 depicts an example computer system that may be used in a virtual integrated circuit fabrication system.

### DETAILED DESCRIPTION

A method and system is provided for linking a product manufacturing facility (for example, a semiconductor foundry) order to one or many quotations. It is to be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

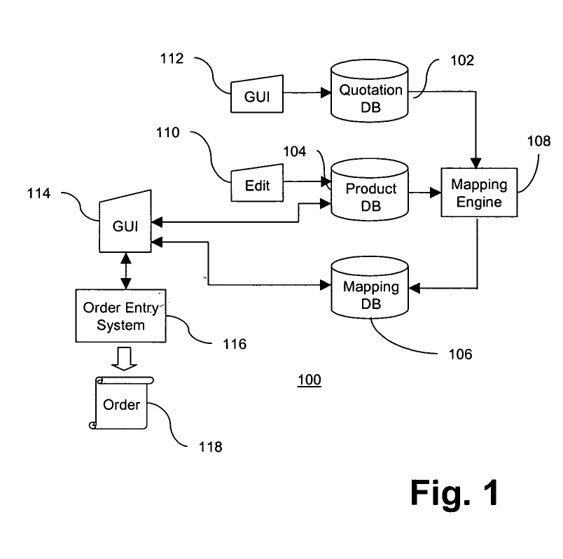

Turning now to FIG. 1, a quotation-to-order linking system 100 for linking semiconductor foundry quotations with customer orders is depicted. A quotation database 102 may store information about quotes provided to customers. The information associated with a single quotation may comprise multiple distinct line items. In one illustrative embodiment, this information is captured in two separate database tables: a quotation header database table and a quotation item database table. The quotation header database table has a single record associated with a single quotation. The quotation item database table has a single record associated with a single quotation line item, and hence a single quotation may be associated with multiple quotation item database table records as would be the case if the quotation is composed of multiple line items. In one embodiment of the present invention the quotation header database table record format includes the following fields:

| Field Name | Field Purpose |
|---|---|
| Quote Number | Identifies a specific quotation |
| Effective Date Type | Designates quotation effective |
| | start date type as relative to |
| | shipping date or relative to order entry date |
| Effective Start Date | Identifies start date of the quotation |
| Effective End Date | Identifies expiration date of the quotation |
| Customer Code | Identifies customer by a code |
| Quote Special Term | Designates any understood |
| | contingencies of the quote (e.g., |
| | volume based) |
| Quote Approved | Identifies date/time |
| Date/Time | |

In one embodiment of the present invention, the quotation item database table record format includes the following fields:

| Field Name | Field Purpose |
|---|---|
| Quote Line Item Number | Identifies a quotation line item |
| Quote Number | Identifies quotation to which this quotation |
| | line item associates |
| Quoted Wafer Line | Identifies wafer type |
| Description | |
| Quoted Wafer Price | Price |
| Quoted CP Line | Description of Circuit Probe (CP) functionality, |
| Description | if any applies |
| Quoted CP Price | Price |

Note that the quote number may be used to search through the quotation item database table to find all quote line items associated with the searched quotation number.

A product database table 104 stores information about products and the technologies on which the product is built. In one embodiment of the present invention this information is captured in a product master database table whose record format includes the following fields:

| Field Name | Field Purpose |
|---|---|
| Product Name | Identifies product |
| Service Flow | Identifies service flow |
| Product Class | Identifies product by class |
| WF Technology | Identifies wafer technology |
| WF Option | Identifies wafer option, if used |
| CP Tester | Identifies Circuit Probe (CP) tester, if used |
| CP Option | Identifies Circuit Probe (CP) option, if used |
| BP Type | Identifies bumping type, if used |
| CF Type | Identifies Color Filter (CF), if used |

A mapping database 106 stores information, which associates quotation price and other information with product name. In one embodiment of the present invention, this information is captured in a customized view database table whose record format includes the following fields:

| Field Name | Field Purpose |
|---|---|
| Product Name | Identifies device |
| WF Price | Total price of wafer (WF) line items |
| WF Price Effective Date Type | Designates quotation |
| | effective start date as relative to |
| | shipping date or to order entry date |
| WF Price Effective Start Date | Identifies start date of the WF Price |
| WF Price Effective End Date | Identifies expiration date of the WF Price |
| WF Price Special Term | Designates any understood |
| | contingencies of the price |
| | (e.g. volume based) |
| CP Price | Total price of circuit probe line items |
| CP Price Effective Date Type | Designates quotation |
| | effective start date as relative to |
| | shipping date or to order entry date |
| CP Price Effective Start Date | Identifies date |
| CP Price Effective End Date | Identifies date |
| CP Price Special Term | Designates any understood |
| | contingencies of the price |
| | (e.g. volume based) |

A mapping engine 108 maps changes in both or either the quotation database 102 or product database 104 to record modifications or record insertions in the mapping database 106. This mapping includes accumulating prices associated with quotation line items to come up with a total price for wafer and a total price for circuit probe (CP) product. In FIG. 1, this mapping engine is shown as a separate functional block, but in some embodiments of the present invention this function may be accomplished by automatic mapping database mechanisms, including database triggers or auto-call functions. Database triggers and/or database auto-call functions have the property of being invoked when specific database tables are modified and of creating a related change in another database table or tables.

A record editing capability 110 communicates with the product database 104, permitting a user to define new products and/or new product class attributes in the product database 104. A graphical user interface (GUI) 112 communicates with the quotation database 102, permitting a user to create a quotation in the quotation database 102.

A GUI 114 communicates with the mapping database 106, the product database 104, and an order entry system 116 to create a customer order 118. The GUI permits a user to create the customer order and employ pricing information taken from the mapping database table 106. The GUI invokes commands on the order entry (OE) system providing the necessary product and pricing information to cause the OE to generate a customer order.

In some embodiments of the present invention, the product master, quotation header, and quotation line item database tables may be encapsulated so as to provide differently privileged users access to different views or layers of the encapsulated database tables. In some embodiments of the present invention, Siebel Workflow, (Siebel Systems, Inc. of California) may be used to manage some of the databases. In some embodiments of the present invention, changes to the product database 104 may be introduced by other business processes independently of the editing functionality 110.

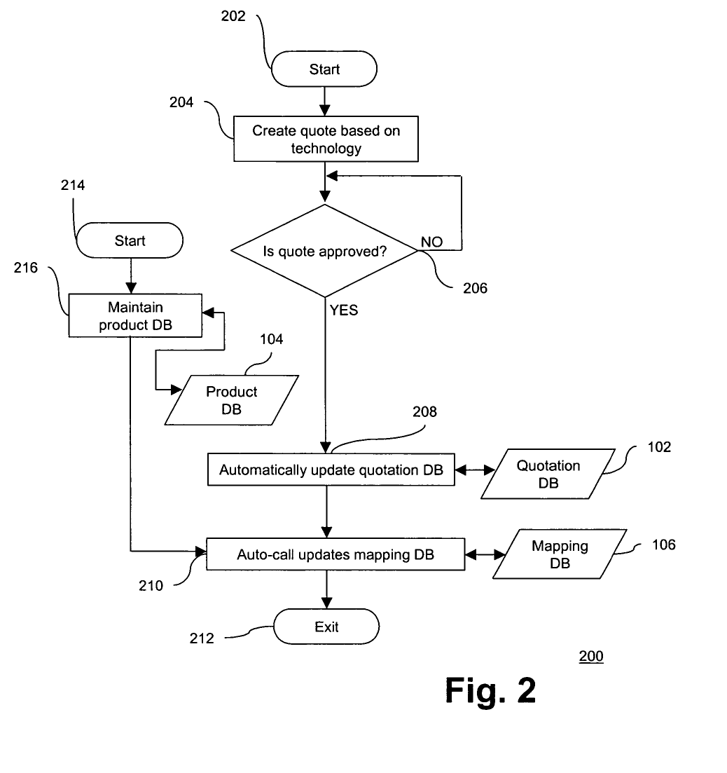

Turning now to FIG. 2, a process 200 for creating a semiconductor foundry quotation, for updating the quotation database 102, for updating the product database 104, and for updating the mapping database 106 is depicted. The process may start at step 202 when the GUI 112 is started. The process flows to step 204 in which a semiconductor foundry quote is created by specifying technology. The process flows to step 206 where a decision is made: if the quote is not approved by other business processes the process remains indefinitely in step 206—the process is blocked on step 206—until the quote is approved. When the quote is approved, the process flows to step 208 where the quotation database 102 is automatically updated. This automatic update may be effected by a database trigger mechanism or a database auto-call function. The process flows to step 210 where the mapping database 106 is automatically updated. This automatic update may be effected by a database trigger mechanism or a database auto-call function. The process flows to step 212 where the process exits. In some embodiments this process may support a decision after step 210 to loop back up to step 204 to enable the user to create multiple semiconductor foundry quotations during a single GUI session if this option is elected in the decision.

The process may also start at step 214 when the record editing capability 110 session is started. The process flows to step 216 in which the product database 104 is edited to change product information or to add new product information, thus updating the product database 104. The process then flows to step 210 where the mapping database 106 is automatically updated. This automatic update may be effected by a database trigger mechanism or a database auto-call function. The process flows to step 212 where the process exits.

The ultimate result of the process 200, starting either from step 202 or step 214, is that the mapping database 106 is updated.

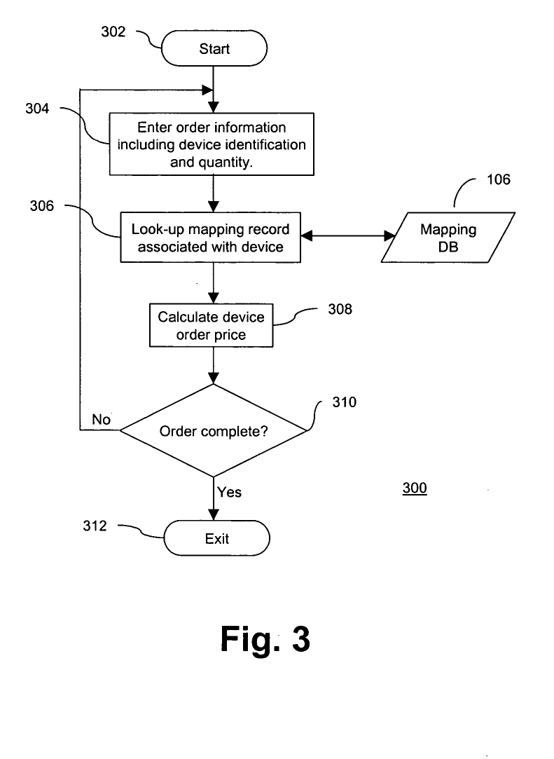

Turning now to FIG. 3, a process 300 for creating a semiconductor foundry order is depicted. The process begins when the GUI 114 is started. The process flows to step 304 where the order information including customer identification, device identification, and quantity is entered. The process flows to step 306 where the mapping record associated with this device is retrieved from the mapping database 106. In the present embodiment, it is assumed that the placement of a semiconductor foundry order is first preceded by an one or more associated quotations to the customer. The process flows to step 308 where the price of the order is calculated based on the information in the mapping record retrieved from the mapping database 106 in step 306 utilizing a price calculator, which may be any type of computing mechanism. The process flows to step 310 where a decision is made: if additional orders need to be entered, the process returns to step 304. If no additional orders need to be entered, the process flows to step 312 and the process exits.

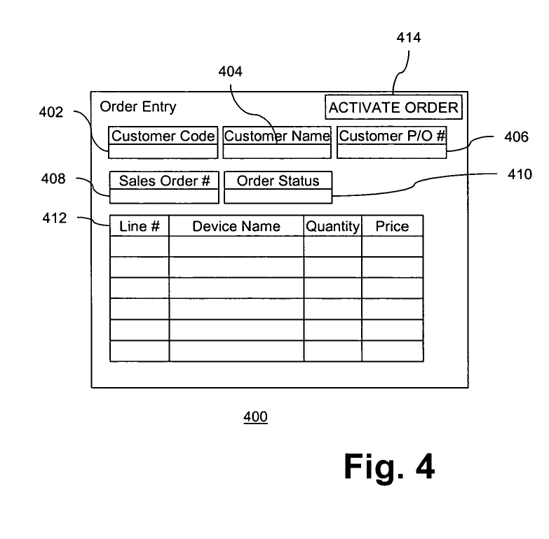

Turning now to FIG. 4, an example GUI screen 400 for creating a semiconductor foundry customer order may be provided by the GUI 114 (FIG. 1). Note that other input fields, buttons, menus, and other input controls may be used. In some embodiments, integration of the GUI screen 400 with other business processes in the deployment stage may require the addition of additional input controls to support these other business processes requirements. The GUI screen 400 as depicted is not meant to limit the range of control capabilities or functionalities of this embodiment, and those skilled in the art may readily identify obvious refinements of the GUI screen as here shown. The GUI screen provides text fill-in controls for Customer Code 402, for—Customer Name 404, for Customer Purchase Order Number 406, for Sales Order Number 408, and for Sales Order Status 410. The GUI screen 400 provides a table entry control 412 which includes text fill-in columns for line number, product name, and quantity. In the present embodiment, the price column of table control 412 is not write-able but is for display only. Instead, the order line item price is calculated from the quantity, device name, and the associated mapping database 106 record. The functionality of the GUI 114 ties into the order entry system 116 which is part of the previously existing business process. The actual customer order 118 is generated by the order entry system in response to input from the GUI screen. An ACTIVATE ORDER button 414 has the effect when selected of relaying the order input information on to the order entry system 116 and causing the order entry system 116 to generate the order.

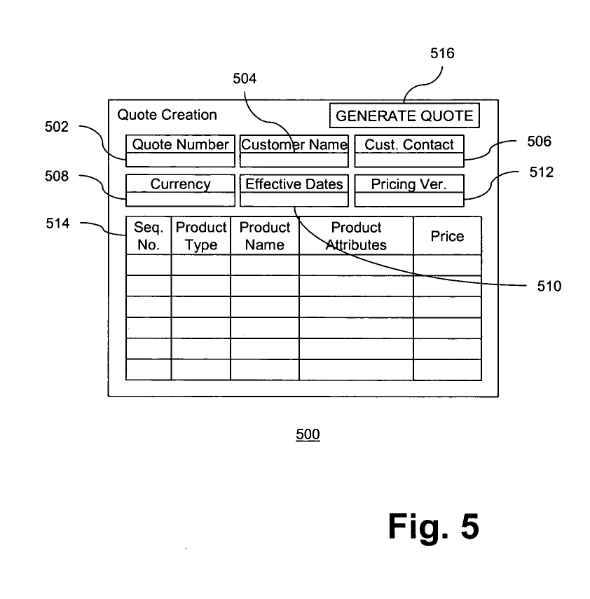

Turning now to FIG. 5, an example GUI screen 500 for creating a semiconductor foundry quotation may be provided by the GUI 112 (FIG. 1). Note that other input fields, buttons, menus, and other input controls may be used. In some embodiments, integration of this GUI screen with other business processes in the deployment stage of this invention may require the addition of additional input controls to support these other business processes requirements. The GUI screen as depicted is not meant to limit the range of control capabilities or functionalities of this embodiment, and those skilled in the art may readily identify obvious refinements of the GUI screen as here shown. The GUI screen 500 provides text fill in controls for Quote Number 502, Customer Name 504, Customer Contact 506, Currency 508, Effective Dates 510, and Pricing Version 512. The GUI screen 500 provides a table entry control 514 which includes text entry fields for sequence number, product type, product name, product attributes, and price. A GENERATE QUOTE button 516 has the effect of completing the quote and submitting it for approval in the business process when the button is selected.

It happens that in the semiconductor foundry business that customer quotations may be produced based on technology while customer orders are entered based on device name. In the past there has been no system to support associating between the quotation and order: the sales associate placing the customer's order had to manually establish this association, look up the appropriate quotation, and extend the order price appropriately. This process is time consuming and subject to error. The present invention contemplates a system which would automatically associate the quotation with the customer's order and calculate the order extended price based on the appropriate quotation, thus conserving time and avoiding errors.

Referring now to FIG. 6, a product manufacturing facility such as virtual IC fabrication system (a “virtual fab”) 600, within which the quotation-to-order linking system 100 of FIG. 1 may exist, is illustrated. The virtual fab includes a plurality of entities 602, 604, 606, 608, 610, 612, 614, . . . , N that are connected by a communications network 616. The network 616 may be a single network or may be a variety of different networks, such as an intranet and the Internet, and may include both wireline and wireless communication channels.

In the example virtual fab 600, the entity 602 represents a service system for service collaboration and provision, the entity 604 represents a customer, the entity 606 represents an engineer, the entity 608 represents a design/laboratory (lab) facility for IC design and testing, the entity 610 represents a fabrication (fab) facility, the entity 612 represents a process (e.g., an automated fabrication process), and the entity 614 represents another virtual fab (e.g., a virtual fab belonging to a subsidiary or a business partner). The quotation-to-order linking system 100 may be incorporated into these entities (for example, quotation database 102 may be populated from fabrication (fab) facility entity 610 and customer 604 may initiate an order through GUI 114) or be implement through an individual entity. Each entity may interact with other entities and may provide services to and/or receive services from the other entities.

For purposes of illustration, each entity 602-612 may be referred to as an internal entity (e.g., the engineer 606, or system process 612) that forms a portion of the virtual fab 600 or may be referred to as an external entity (e.g., customer 604) that interacts with the virtual fab 600. Examples of external entities 204 include a customer, a design provider; and other facilities that are not directly associated or under the control of the fab. Some entities may be both internal and external. For example, the customer 604 may provide updated mask sets (internal) and may purchase the final product/service (external). Also, it is understood that the entities 602-612 may be concentrated at a single location or may be distributed, and that some entities may be incorporated into other entities. In addition, each entity 602-612 may be associated with system identification information that allows access to information within the system to be controlled based upon authority levels associated with each entities identification information.

The virtual fab 600 enables interaction among the entities 602-612 for the purpose of IC manufacturing, as well as the provision of services. In the present example, IC manufacturing includes receiving a customer's IC order in accordance with the present invention and the associated operations needed to produce the ordered ICs and send them to the customer 604, such as the design, fabrication, testing, and shipping of the ICs.

One of the services provided by the virtual fab 600 may enable collaboration and information access in such areas as design, engineering, and logistics. For example, in the design area, the customer 604 may be given access to information and tools related to the design of their product via the service system 602. The tools may enable the customer 604 to perform yield enhancement analyses, view layout information, and obtain similar information. In the engineering area, the engineer 606 may collaborate with other engineers using fabrication information regarding pilot yield runs, risk analysis, quality, and reliability. The logistics area may provide the customer 604 with fabrication status, testing results, order handling, and shipping dates. It is understood that these areas are representative, and that more or less information may be made available via the virtual fab 600 as desired.

Another service provided by the virtual fab 600 may integrate systems between facilities, such as between the design/lab facility 608 and the fab facility 610. Such integration enables facilities to coordinate their activities. For example, integrating the design/lab facility 608 and the fab facility 610 may enable design information to be incorporated more efficiently into the fabrication process, and may enable data from the fabrication process to be returned to the design/lab facility 610 for evaluation and incorporation into later versions of an IC. The process 612 may represent any process operating within the virtual fab 600.

Referring now to FIG. 7, in another embodiment of the virtual fab 600, the entities 602-612 are described with greater details. The service system 602 provides an interface between the customer and the IC manufacturing operations. For example, the service system 602 may include customer service personnel 716, a logistics system 718 for order handling and tracking, and a customer interface 720 for enabling a customer to directly access various aspects of an order.

The logistics system 718 may include a work-in-process (WIP) inventory system 724, a product data management system 726, a lot control system 728, and a manufacturing execution system (MES) 730. The WIP inventory system 724 may track working lots using a database. The product data management system 726 may manage product data and maintain product information such as the product database take 104 (FIG. 1).

The MES 730 may be an integrated computer system representing the methods and tools used to accomplish production. In the present example, the primary functions of the MES 730 may include collecting data in real time, organizing and storing the data in a centralized database, work order management, workstation management, process management, inventory tracking, and document control. The MES 730 may be connected to other systems both within the service system 602 and outside of the service system 602. Examples of the MES 730 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 730 may include such information as a process step sequence for each product.

The customer interface 720 may include an online system 732 and the quotation-to-order linking system 100 (or portions thereof). The online system 732 may function as an interface to communicate with the customer 604, other systems within the service system 602, supporting databases (not shown), and other entities 706-712. The order management system 734 may manage customer orders through GUI 114 and may be associated with another supporting database (not shown) to maintain client information.

Portions of the service system 602, such as the customer interface 720 and/or the quotation-to-order linking system 100, may be associated with a computer system 722. In some embodiments, the computer system 722 may include multiple computers, some of which may operate as servers to provide services to the customer 604 or other entities. The service system 602 may also provide such services as identification validation and access control, both to prevent unauthorized users from accessing data and to ensure that an authorized customer can access only their own data.

The customer 604 may obtain information about the manufacturing of its ICs via the virtual fab 700 using a computer system 736. In the present example, the customer 604 may access the various entities 602, 606-612 of the virtual fab 600 through the customer interface 720 provided by the service system 602. However, in some situations, it may be desirable to enable the customer 604 to access other entities without going through the customer interface 720. For example, the customer 604 may directly access the fab facility 610 to obtain fabrication related data.

The engineer 606 may collaborate in the IC manufacturing process with other entities of the virtual fab 600 using a computer system 738. The virtual fab 600 enables the engineer 606 to collaborate with other engineers and the design/lab facility 608 in IC design and testing, to monitor fabrication processes at the fab facility 610, and to obtain information regarding test runs, yields, etc. In some embodiments, the engineer 606 may communicate directly with the customer 604 via the virtual fab 600 to address design issues and other concerns.

The design/lab facility 608 provides IC design and testing services that may be accessed by other entities via the virtual fab 600. The design/lab facility 608 may include a computer system 740 and various IC design and testing tools 742. The IC design and testing tools 742 may include both software and hardware.

The fab facility 610 enables the fabrication of ICs. Control of various aspects of the fabrication process, as well as data collected during the fabrication process, may be accessed via the virtual fab 600. The fab facility 610 may include a computer system 744 and various fabrication hardware and software tools and equipment 746. For example, the fab facility 610 may include an ion implantation tool, a chemical vapor deposition tool, a thermal oxidation tool, a sputtering tool, and various optical imaging systems, as well as the software needed to control these components.

The process 612 may represent any process or operation that occurs within the virtual fab 600. For example, the process 612 may be the quotation process, a fabrication process that runs within the fab facility 610, a design process executed by the engineer 606 using the design/lab facility 608, or a communications protocol that facilities communications between the various entities 602-612.

It is understood that the entities 602-612 of the virtual fab 600, as well as their described interconnections, are for purposes of illustration only. For example, it is envisioned that more or fewer entities, both internal and external, may exist within the virtual fab 600, and that some entities may be incorporated into other entities or distributed. For example, the service system 602 may be distributed among the various entities 606-610.

Referring now to FIG. 8, an example computer 800 may be used to implement one or more portions of the present embodiments, including the implementation of the quotation-to- order system 100 within the virtual fab 600 of FIG. 6. The computer 800 may include a central processing unit (CPU) 802, a memory unit 804, an input/output (I/O) device 806, and a network interface 808. The network interface may be, for example, one or more network interface cards (NICs). The components 802, 804, 806, and 808 are interconnected by a bus system 810. It is understood that the computer 800 may be any processing device (for example, a stand alone computer, a network of computers, a personal data assistant, etc.) and may be differently configured and that each of the listed components may actually represent several different components. For example, the CPU 802 may actually represent a multi-processor or a distributed processing system; the memory unit 804 may include different levels of cache memory, main memory, hard disks, and remote storage locations; and the I/O device 806 may include monitors, keyboards, and the like.

The computer 800 may be connected to a network 812, which may be connected to the networks 616 (FIGS. 6, 7). The network 812 may be, for example, a complete network or a subnet of a local area network, a company wide intranet, and/or the Internet. The computer 800 may be identified on the network 812 by an address or a combination of addresses, such as a media control access (MAC) address associated with the network interface 808 and an internet protocol (IP) address. Because the computer 800 may be connected to the network 812, certain components may, at times, be shared with other devices 814, 816. Therefore, a wide range of flexibility is anticipated in the configuration of the computer. Furthermore, it is understood that, in some implementations, the computer 800 may act as a server to other devices 814, 816. The devices 814, 816 may be computers, personal data assistants, wired or cellular telephones, or any other device able to communicate with the computer 800.

Although only a few example embodiments of this invention have been described in detail above, those skilled in the art will readily appreciate that many modifications are possible in the example embodiments. Accordingly, all such modifications are intended to be included in the scope of this invention as defined in the following claims. In the claims, means-plus-function clauses are intended to cover the structures described herein as performing the recited function and not only structural equivalents, but also equivalent structures.

1. A computer-implemented method for linking a semiconductor product manufacturing facility order with a quotation, the method comprising:
receiving the quotation including at least a first product and its quote amount;
storing the quote amount associated with the first product;
receiving the product manufacturing facility order that identifies at least the first product and desired quantity; and
calculating an order price associated with the first product by
accessing the stored quote amount associated with the first product, and
determining the order price based on the quote amount associated with the first product and the desired quantity identified in the product manufacturing facility order.

2. The computer-implemented method of claim 1 wherein the product manufacturing facility is a semiconductor foundry.

3. The computer-implemented method of claim 1 wherein the quote amount is stored in a quotation database.

4. The computer-implemented method of claim 3, and further comprising:
storing predetermined information associated with the first product in a product database;
updating a mapping database with predetermined information from the quotation database and the product database associated with the first product;
wherein the order price is calculated by accessing the quote amount from determining the order price based on the quote amount from the mapping database associated with the first product and the quantity identified in the product manufacturing facility order.

5. The computer-implemented method of claim 4, wherein the mapping database is updated automatically when the quotation database is changed.

6. The computer-implemented method of claim 5, wherein the mapping database is updated automatically when a new quotation is entered into the quotation database utilizing a database trigger.

7. The computer-implemented method of claim 5, wherein the mapping database is updated automatically when a new quotation is entered into the quotation database utilizing a auto-call function.

8. The computer-implemented method of claim 4, wherein the mapping database is updated automatically when the product database is changed.

9. The computer-implemented method of claim 1, further comprising:
receiving a quote amount for a second product;
storing the quote amount associated with the second product; and
calculating an order price associated with the second product, wherein the received the product manufacturing facility order identifies at least the first product and the second product and desired respective quantities, by
accessing the stored quote amount associated with the second product, and
determining the order price for the second product based on the stored quote amount associated with the second product and the desired quantity identified in the product manufacturing facility order.

10. The computer-implemented method of claim 9, wherein the quote amount associated with the first product and the quote amount associated with the second product are in the same quotation.

11. A computer-implemented method for linking a semiconductor product manufacturing facility order with a quotation, the method comprising:
receiving the quotation including at least two products and their respective quote amounts;
storing the two quote amounts;
receiving the product manufacturing facility order that identifies at least the two products and their respective desired quantities; and
calculating order prices associated with the at least two products by
accessing the quote amounts associated with the products, and
determining the order prices based on the respective quote amounts associated with the products and their respective desired quantities identified in the product manufacturing facility order.

12. The computer-implemented method of claim 11, wherein the product manufacturing facility is a semiconductor foundry.

13. The computer-implemented method of claim 11, wherein the quote amounts are stored in respective quotation database records in a quotation database.

14. The computer-implemented method of claim 13, further comprising:
storing predetermined information associated with the first product and second product in respective product database records;
updating respective mapping database records in a mapping database with predetermined information from the quotation database records and the product database records associated with the first product and second product;
wherein the order prices are calculated by accessing the quote amounts from the respective mapping database records associated with the products and determining the order prices based on the quote amounts from the mapping database records associated with the products and the respective quantities identified in the product manufacturing facility order.

15. The computer-implemented method of claim 14, wherein the mapping database is updated automatically when the quotation database is changed.

16. The computer-implemented method of claim 15, wherein the mapping database is updated automatically when a new quotation is entered into the quotation database utilizing a database trigger.

17. The computer-implemented method of claim 15, wherein the mapping database is updated automatically when a new quotation is entered into the quotation database utilizing a auto-call function.

18. The computer-implemented method of claim 14, wherein the mapping database is updated automatically when the product database is changed.

19. A computer-readable medium having stored thereon sequences of instruction for responding to a request for linking a semiconductor product manufacturing facility order with a quotation, the sequence of instructions including instructions for performing the steps of:
receiving the quotation including at least a first product and its quote amount;
storing the quote amount;
receiving the product manufacturing facility order that identifies at least the first product and desired quantity; and
calculating an order price associated with the first product by
accessing the quote amount associated with the first product, and
determining the order price based on the quote amount associated with the first product and the quantity identified in the product manufacturing facility order.

20. The computer-readable medium of claim 19, wherein the product manufacturing facility is a semiconductor foundry.

21. The computer-readable medium of claim 19, wherein the sequence of instructions further comprises instructions for performing the steps of:
storing the quotation amount in a quotation database.

22. The computer-readable medium of claim 21, the sequence of instructions further comprises instructions for performing the steps of:
storing predetermined information associated with the first product in a product database;
updating a mapping database with predetermined information from the quotation database and the product database associated with the first product;
wherein the order price is calculated by accessing the quote amount from the mapping database associated with the first product and determining the order price based on the quote amount from the mapping database associated with the first product and the quantity identified in the product manufacturing facility order.

23. The computer-readable medium of claim 22, wherein the mapping database is updated automatically when a new quotation is entered into the quotation database utilizing a database trigger

24. The computer-readable medium of claim 22, wherein the mapping database is updated automatically when a new quotation is entered into the quotation database utilizing a auto-call function.

25. The computer-readable medium of claim 22, wherein the mapping database is updated automatically when the product database is changed.

26. A system for linking a product manufacturing facility order with a quotation, the system comprising:
a quotation entry device for entering the quotation that includes at least a first product and its quote amount;
memory connected to the data entry device configured to receive the quote amount;
an order entry device for entering the product manufacturing facility order that identifies at least the first ordered product and the desired quantity; and
a price calculator configured to receive the product manufacturing facility order from the order entry device, to access the memory to identify the quote amount associated with the ordered product, and to calculate a price for the product based on the desired quantity and the quote amount.

27. The system of claim 26, wherein the product manufacturing facility is a semiconductor foundry.

28. The system of claim 26, wherein the memory comprises
a quotation database connected to the order entry device;
a product database configured to receive product information; and
a mapping database that interfaces with both the quotation database and product database capable of storing information associated with the product.

29. The system of claim 28, wherein the quotation database additionally comprises an automatic updating mapping database mechanism which updates the mapping database when the quotation database is changed.

30. The system of claim 28, wherein the product database additionally comprises
an automatic updating mapping database mechanism which updates the mapping database when the product database is changed.

31. The system of claim 26, wherein the quotation entry device and the order entry device comprise a single device.

32. The system of claim 31, wherein the single device is a personal data assistant.

33. The system of claim 26, wherein the quotation entry device is connected to the memory via a wireless connection.

34. The system of claim 26, wherein the order entry device is connected to the price calculator via a wireless connection.
